(19) United States
(12) Patent Application Publication
(10) Pub. No.: US 2026/0098112 A1
(43) Pub. Date: Apr. 9, 2026

(54) METHOD OF MAKING A MORPHOLOGY-IMPROVED POLYETHYLENE POWDER

(71) Applicant: Dow Global Technologies LLC, Midland, MI (US)

(72) Inventors: Kishori Deshpande, Pearland, TX (US); Lalit A. Darunte, Sunnyvale, CA (US); Pritishma Lakhe, Huntersville, NC (US)

(21) Appl. No.: 19/114,830

(22) PCT Filed: Dec. 11, 2023
(86) PCT No.: PCT/US2023/083278

§ 371 Date: Mar. 25, 2025

Related U.S. Application Data
(60) Provisional application No. 63/476,017, filed on Dec. 19, 2022.

(51) Int. Cl. C08F 210/18; B01J 31/12; B01J 37/00; C08F 2/14; C08F 4/76; C08J 3/12

(52) U.S. Cl. CPC C08F 210/18; B01J 31/12; B01J 37/0045; C08F 2/14; C08F 4/76; C08J 3/12; B01J 2531/46; B01J 2531/48; B01J 2531/49; C08F 2420/07; C08F 2420/10; C08J 2323/08

(57) ABSTRACT

A method of making a morphology-improved polyethylene powder, the method comprising: contacting ethylene with a reactive olefin prepolymer in a gas phase reactor to make a morphology-improved polyethylene powder via gas phase polymerization; wherein the reactive olefin prepolymer comprises a component that is a polyolefin and a component that is an active metallocene derivative of a spray-dried silica-supported metallocene catalyst; wherein the reactive olefin prepolymer has a prepolymer/catalyst weight/weight ratio from 10:1.0 to 50:1.0, wherein the prepolymer weight is the total weight of the reactive olefin prepolymer and the catalyst weight is the weight of the spray-dried silica-supported metallocene catalyst.

### FIELD

Polymerizing ethylene with a catalyst in a gas phase reactor.

### INTRODUCTION

Patent application publications, patents, and unpublished patent applications in or about the field include EP1939226A1, US2008/0182950A1, U.S. Pat. Nos. 5,654,248, 7,592,410B2, WO1992/012182A1, WO1997/002297A1. WO2002/074818A1, WO2005/005495A2, WO2007/033941A1, WO 2016/172567 A1, WO2021/242800A1, WO2021/242801A1. PCT/US2022/031696, and PCT/US2022/043943.

A gas phase reactor lacks much of the heat-absorbing mass present in a solution phase reactor, which contains a large amount of solvent. Because ethylene polymerization is a highly exothermic reaction, gas phase polymerizations of ethylene are especially vulnerable to overheating. When overheating occurs, the rate of reactor fouling increases substantially. Mitigating factors lessen these problems with higher olefin monomers. These factors include steric hindrance of the olefin monomer molecule and melting temperature of the polyolefin. All other things being equal, as the size of the olefin monomer being polymerized increases, the amount of exotherm decreases. Further, as the melting temperature of the polyolefin increases, the reactor fouling problem decreases because higher melting particles are less prone to fusing together at a given temperature than lower melting particles. Indeed the propene molecule is larger than the ethylene molecule and the melting temperature of polypropylene is significantly higher than that of polyethylene. Adding the effects of these differences mean problems with gas phase polymerization of ethylene are unique in type and extent.

In the field of fluidized bed, gas phase polymerization of olefin monomers to make polyolefin polymer powders, particle size and particle size distribution of the polyolefin powders in a gas phase reactor during polymerization may influence the process and its product. This influence is felt particularly in process making polyolefin polymers having a multimodal (e.g., bimodal or trimodal) molecular weight distribution. If there are too many small polyolefin particles, referred to herein as polyolefin fines, in the reactor, these fines can foul reactor equipment such as compressors and other equipment. When the gas phase reactor is a fluidized bed reactor, the fines can also have a negative impact on the fluidization of a bed of polyolefin particles (fluidized bed) in the gas phase reactor and can cause sintering effects leading to formation of polymer chunks and sheets. Also, discharging the polyolefin powder from the reactor and conveying it to a downstream unit operation (e.g., a purge bin) is negatively influenced. A broad variation of particle sizes affects the bed fluidization because particles with a size that deviates significantly from the average size behave significantly different in a fluidized bed. Threats to the process from particles with such a relatively large or small size include different reactivities, different cooling capacities, and particle sintering. A consequence of this problem is that the particles are made that have different polymer properties. This problem is known as chemical inhomogeneity. Further, broader particle size distributions could lead to polyolefin powder segregation, thereby leading to processing challenges. Also, this problem can produce physical inhomogeneity due to different melt behaviors and formation of gels in the final polyolefin powder. All other things being equal, a narrower particle size distribution of polyolefin powders made in gas phase polymerization reactors is preferred.

### SUMMARY

Embodiments our technical solution to this problem includes shifting particle size distribution of polyolefin powders made in gas phase reactors to larger size particles so that the number of polyolefin fines is minimized. However, a simple shift of the particle size distribution to larger particle size values, i.e., by shifting the particle size range by a certain amount does not inherently change the broadness of the distribution. For example, shifting a particle size distribution by, for example, 20 μm from a first range from 60 μm to 200 μm to a second range from 80 μm to 220 μm does not change the broadness of the particle size distribution: in both the first and second ranges the broadness of the distribution is the same: 140 μm. The present invention comprises making a reactive polyolefin prepolymer. This reactive polyolefin prepolymer enables narrowing particle size distributions of polyolefin powders made in fluidized bed gas phase reactors. This can be done by tuning the temperature used to make the prepolymer or by changing catalyst loading in the prepolymer or both. In some embodiments the present invention comprises a process for making polyolefin powder wherein the polyolefin particles have a particle size distribution that is narrower than a particle size distribution of a comparative polyethylene powder.

The invention generally relates to a method of making a morphology-improved polyethylene powder during gas phase polymerization of ethylene catalyzed by an active metallocene derivative of a spray-dried silica-supported metallocene catalyst (“SD/SIS-metallocene catalyst”). Without this method, the SD/SiS-metallocene catalyst would make polyethylene powder with too many fines and too small of an average particle size (APS).

When making a polyethylene powder by catalyzing ethylene polymerization by feeding a SD/SiS-metallocene catalyst in dry or slurry form into a reaction zone of a gas phase reactor, we observed overheating in the reaction zone. Surprisingly this problem created opposite particle size defects. On the one hand the overheating generated polyethylene fines, defined as polyethylene particles having diameters of 74 micrometers or less. Without being bound by theory this may be due to the overheating causing fracturing some of the SD/SIS-metallocene catalyst particles into smaller sizes, which comprise or produce the polyethylene fines. Some polyethylene fines may be due to catalyst particle fines that may be present in the starting SD/SIS-metallocene catalyst. On the other hand the overheating caused reaction zone fouling, as exemplified by reactor wall sheeting or distribution plate clogging. Without being bound by theory this fouling may be due to the overheating causing fusing of polyethylene powders into agglomerated particles and sheets.

One attempt to solve these problems was to switch from a simple single-tube injector body to a tube-in-tube injector body to feed the SD/SiS-metallocene catalyst into the reaction zone. The tube-in-tube injector body feeds the SD/SIS-metallocene catalyst through one of the tubes and feeds a carrier gas through the other tube. This tube-in-tube construct more quickly and widely disperses the supported metallocene catalyst in the reaction zone compared to the dispersal from a single tube injector. The tube-in-tube injector did not eliminate the overheating problem.

The path to the present technical solution started with an observation: all other things being equal, the SD/SiS-metallocene catalyst had significantly faster light-off than the conventionally-dried system when injected into the gas phase reactor. Catalyst light-off means how quickly fresh catalyst begins to react exothermically with monomer after being injected into the reactor and/or how quickly the temperature in the reactor increases once the reaction starts. Usually there is a lag period between time-zero when the fresh catalyst is injected into the reactor and time-onset when the catalyst begins to make polymer. If the lag period is too short, the fresh catalyst may not have time to disperse widely in the reaction zone before it starts making polymer. This is worse with single tube injectors. That can cause localized overheating. Once the fresh catalyst begins to polymerize ethylene, the reaction generates a significant exotherm. If the exotherm is too strong, even widely dispersed catalyst can overheat and cause fouling. All other things being equal, the earlier the onset of exotherm (i.e., the shorter the lag period) and/or the faster the rate of increase in temperature, the faster the catalyst's light-off. Conversely, the later the onset of exotherm (i.e., the longer the lag period) and/or the slower the rate of increase in reactor temperature, the slower the catalyst's light-off. A catalyst's lag period and exotherm may be quantified by injecting fresh catalyst into vials containing room temperature 1-octene as monomer, and recording time and temperature, such as described later in the Light-Off Vial Test Method.

Upon investigation using scanning electron microscopy (SEM), we discovered morphological differences between the particles of the SD/SIS-metallocene catalyst versus the particles of the conventionally-dried supported metallocene catalyst. Because the same reactants and amounts were used to make these catalysts, these morphological differences seem to be an inherent result of the different drying methods.

The conventionally dried supported metallocene catalyst is prepared by evaporatively concentrating a mixture of a metallocene precatalyst, a silica support, activator, and a hydrocarbon solvent to give conventional catalyst particles. The conventional drying process yields a particle morphology comprising an intimate blend of distinct particles of the metallocene catalyst and distinct particles of the activator/silica support. The SD/SIS-metallocene catalyst is prepared by spray drying the mixture of a metallocene precatalyst, a silica support, activator, and a hydrocarbon solvent to give conventional catalyst particles. Spray drying flashes off the hydrocarbon solvent and yields particles having a core-shell morphology wherein the metallocene catalyst and excess activator are mainly in the form of a thin shell disposed on the surface of the silica support and the silica support comprises the cores of the core-shell particles. The different particle morphologies produced by the conventional drying process and the spray-drying process can be visualized by scanning electron microscopy (SEM). The differences in particle morphologies are believed to produce different catalyst light-off profiles and different catalyst activities.

Without being bound by theory we believe the morphological differences between conventionally-dried and SD/SiS-metallocene catalysts explain the significantly faster light-off of the SD/SiS-metallocene catalyst in gas phase reactor. The differences in light-off “potency” can be quantified using the Light-Off Vial Test Method.

Thus, the problem we addressed is how to inhibit, but not too much, light-off of a SD/SIS-metallocene catalyst in ethylene polymerization in a gas phase reactor.

The problem is solved by the inventive method. The method comprises making a morphology-improved polyethylene powder, the method comprising: contacting ethylene with a reactive olefin prepolymer in a gas phase reactor to make a morphology-improved polyethylene powder via gas phase polymerization; wherein the reactive olefin prepolymer comprises a component that is a polyolefin and a component that is an active metallocene derivative of a spray-dried silica-supported metallocene catalyst; wherein the reactive olefin prepolymer has a prepolymer/catalyst weight/weight ratio from 10:1.0 to 50:1.0, wherein the prepolymer weight is the total weight of the reactive olefin prepolymer and the catalyst weight is the weight of the spray-dried silica-supported metallocene catalyst.

Unexpectedly, solving the catalyst light-off problem also improves the morphology of the polyolefin powders made in the gas phase polymerization. The improved morphology comprises: (i) inhibiting formation of polyethylene particles that are too small (fines), which is defined as polyethylene particles having diameters of 74 micrometers or less; (ii) changing average particle size (APS) of the polyethylene particles; (iii) narrowing particle size distribution of the polyolefin particles (e.g., polyethylene particles); (iv) both feature (i) and feature (ii); (v) both feature (i) and feature (iii); (vi) both feature (ii) and feature (iii); or (vii) each of features (i), (ii), and (iii).

### BRIEF DESCRIPTION OF THE DRAWINGS

FIG. 1 is a plot of volume percent (volume %) (y-axis) versus particle size in micrometers (μm) (x-axis) for the SD/SiS-metallocene catalysts of Sample A and Sample B of Preparation 1.

FIG. 2 is a plot of volume fraction in percent (Fraction, %) (y-axis) versus particle size in micrometers (Particle Size (microns)) on a scale from 0 μm to 2,000 μm.

FIG. 3 is a plot of weight percent (wt %) particles versus mesh size (MSH) of particles for two comparative polyethylene powders and two inventive morphology-improved polyethylene powders.

FIG. 4 is a cartoon drawing illustrating particle morphologies of a plurality of conventionally dried catalyst particles.

FIG. 5 is a cartoon drawing illustrating a core-shell particle morphology of a single spray-dried catalyst particle.

### DETAILED DESCRIPTION

A method of making a morphology-improved polyethylene powder, the method comprising: contacting ethylene with a reactive olefin prepolymer in a gas phase reactor to make a morphology-improved polyethylene powder via gas phase polymerization; wherein the reactive olefin prepolymer comprises a component that is a polyolefin and a component that is an active metallocene derivative of a spray-dried silica-supported metallocene catalyst (“SD/SIS-metallocene catalyst”); wherein the reactive olefin prepolymer has a prepolymer/catalyst weight/weight ratio from 10:1.0 to 50:1.0, wherein the prepolymer weight is the total weight of the reactive olefin prepolymer and the catalyst weight is the weight of the spray-dried silica-supported metallocene catalyst. The total weight of the reactive olefin prepolymer includes the weight of the olefin prepolymer plus the weight of the SD/SIS-metallocene catalyst. The weight of the reactive olefin prepolymer is a measured amount thereof added to the gas phase reactor prior to and during the contacting step. In some embodiments the method comprises a step of adding the measured amount of the reactive olefin prepolymer to the gas phase reactor before, during, or before and during the contacting step. The weight of the SD/SiS-metallocene catalyst is the measured amount of SD/SIS-metallocene catalyst that is used to obtain the reactive olefin prepolymer according to the method of making the reactive olefin prepolymer as described herein.

The method as described above comprising making the reactive olefin prepolymer by combining a measured preparatory amount of an olefin monomer with a measured amount of the spray-dried silica-supported metallocene catalyst in an alkane liquid phase in a slurry phase reactor at a temperature from 30° to 70° C., an ethylene partial pressure of no more than 861 kilopascals (kpa) (no more than about 125 psi), and a total reactor pressure of no more than 2445 kilopascals (kpa, no more than about 355 psi) to make the reactive olefin prepolymer via slurry phase polymerization; wherein the measured preparatory amount of olefin monomer and the measured amount of the spray-dried silica-supported metallocene catalyst result in the reactive olefin prepolymer having the prepolymer/catalyst weight/weight ratio from 10:1.0 to no more than 50:1.0, wherein the prepolymer weight is the total weight of the reactive olefin prepolymer and the catalyst weight is the weight of the spray-dried silica-supported metallocene catalyst. The prepolymer/catalyst weight/weight ratio may be adjusted within this range by using higher or lower amounts of the spray-dried silica-supported metallocene catalyst relative to the amount of olefin monomer.

The method as described above having any one of limitations (i) to (iii): (i) the prepolymer/catalyst weight/weight ratio is from 10:1.0 to 45:1.0, from 15:1.0 to 35:1.0, or from 15:1.0 to 25:1.0; (ii) the temperature of the slurry phase reactor in claim 2 is from 35° to 70° C., from 40° to 60° C., or from 45° to 55° C.; or (iii) the prepolymer/catalyst weight/weight ratio is from 15:1.0 to 25:1.0 and the temperature of the slurry phase reactor in claim 2 is from 45° to 55° C.

The method as described above having limitation (i) and limitation (ii) or (iii): (i) the reactive olefin prepolymer is a reactive ethylene prepolymer and the polyolefin of the reactive ethylene prepolymer is an ethylene homopolymer or an ethylene/(C₄-C₁₀)alpha-olefin copolymer; and (ii) the gas phase reactor is free of an olefin comonomer and the morphology-improved polyethylene powder is an ethylene homopolymer; or (iii) the gas phase reactor includes a (C₄-C₁₀)alpha-olefin comonomer and the morphology-improved polyethylene powder is an ethylene/(C₄-C₁₀)alpha-olefin copolymer.

The method as described above comprising: (i) feeding the reactive olefin prepolymer from a slurry phase reactor directly into the gas phase reactor (i.e., without feeding the reactive olefin prepolymer into an intermediate vessel such as a drier, purge bin, or storage tank); or (ii) feeding the reactive olefin prepolymer from a slurry phase reactor into an intermediate vessel (such as a drier, purge bin, or storage tank), waiting for a period of time, and then feeding the reactive olefin prepolymer from the intermediate vessel into the gas phase reactor.

The method as described above wherein the reactive olefin prepolymer is fed via a single inlet tube into the gas phase reactor, wherein the single inlet tube has an inner diameter from 0.3 centimeter (cm) to 1.0 cm.

The method as described above comprising making the spray-dried silica-supported metallocene catalyst by any one of preparations (i) to (iii): (i) spray-drying a mixture of a metallocene precatalyst, a silica support, an activator, and hydrocarbon diluent to make the spray-dried silica-supported metallocene catalyst; (ii) spray-drying a mixture of a silica support, an activator, and hydrocarbon diluent to give a spray-dried supported activator, and contacting the spray-dried supported activator with a metallocene precatalyst to make the spray-dried silica-supported metallocene catalyst; or (iii) spray-drying a mixture of a metallocene precatalyst, a silica support, and hydrocarbon diluent to give a spray-dried supported metallocene precatalyst, and contacting the spray-dried supported metallocene precatalyst with an activator to make the spray-dried silica-supported metallocene catalyst; wherein the hydrocarbon diluent is selected from the group consisting of an alkane, an aromatic hydrocarbon, an alkyl-substituted aromatic hydrocarbon, an aryl-substituted alkane, or a blend of any two or more thereof.

The method as described above wherein the metallocene precatalyst is of formula (I):

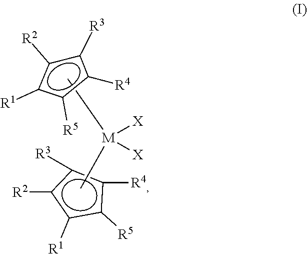

wherein M is Ti, Hf, or Zr; each R¹ to R⁵ is independently an unsubstituted (C₁-C₆)alkyl group or R¹ and R² on one of the cyclopentadienyl rings are bonded together to comprise a divalent hydrocarbylene selected from the group consisting of: —C(R^{a})═C(R^{b})—C(R^{c})═C(R^{c})— and —C(R^{a})₂—C(R^{b})₂—C(R^{c})₂—C(R^{d})₂—, wherein each of R^{a} to R^{d} independently is H or methyl; and each X is a leaving group.

The method as described above wherein the metallocene precatalyst is selected from the group consisting of: bis(η⁵-tetramethylcyclopentadienyl)zirconium dichloride; bis(η⁵-tetramethylcyclopentadienyl)zirconium dimethyl; bis(η⁵-dichloride; pentamethylcyclopentadienyl)zirconium bis(η⁵-pentamethylcyclopentadienyl)zirconium dimethyl; (1,3-dimethyl-4,5,6,7-tetrahydroindenyl)(1-methylcyclopentadienyl)zirconium dimethyl; bis(1-methyl-3-n-butylcyclopentadienyl)zirconium dichloride; bis(1-methyl-3-n-butylcyclopentadienyl)zirconium dimethyl; bis(n-propylcyclopentadienyl) hafnium dichloride; bis(n-propylcyclopentadienyl) hafnium dimethyl; bis(n-butylcyclopentadienyl)zirconium dichloride; (cyclopentadienyl)(1,5-dimethylindenyl)zirconium dimethyl; (methylcyclopentadienyl)(1,5-dimethylindenyl)zirconium dimethyl; (cyclopentadienyl)(1,4-dimethylindenyl)zirconium dimethyl; (methylcyclopentadienyl)(1,4-dimethylindenyl)zirconium dimethyl; and bis(n-butylcyclopentadienyl)zirconium dimethyl.

The method as described above wherein the morphology of the morphology-improved polyethylene powder is further improved by removing at least some catalyst fines from the spray-dried silica-supported metallocene catalyst before making the reactive olefin prepolymer therewith, wherein catalyst fines are defined as catalyst particles having a diameter of 10 micrometers (μm) or less.

The improved morphology comprises: (i) inhibiting formation of polyolefin particles (e.g., polyethylene particles) that are too small (fines), which is defined as polyolefin particles (e.g., polyethylene particles) having diameters of 74 micrometers or less; (ii) changing average particle size (APS) of the polyolefin particles (e.g., polyethylene particles); (iii) narrowing particle size distribution of the polyolefin particles (e.g., polyethylene particles); (iv) both feature (i) and feature (ii); (v) both feature (i) and feature (iii); (vi) both feature (ii) and feature (iii); or (vii) each of features (i), (ii), and (iii).

In some embodiments the improved morphology comprises feature (i) and the inhibiting formation of polyolefin fines (polyethylene fines) having diameters of 74 micrometers or less comprises a percent decrease in fines from 5% to 60%, or from 9% to 55%, or from 20% to 55%, or from 30% to 55%, or from 45% to 59%.

In some embodiments the improved morphology comprises feature (ii) and increasing the APS of the polyolefin particles (e.g., polyethylene particles), which indicates an overall shifting of the particle size distribution curve to higher diameters. In some embodiments the APS of the polyolefin particles is increased by from 9% to 50%, or from 9% to 42%, or from 30% to 55%. All other things being equal, polyolefin particles (e.g., polyethylene particles) having an increased APS may beneficially have fewer polyolefin fines (e.g., polyethylene fines) and/or may have improved flow characteristics and be easier to transfer from the gas phase reactor to another unit operation such as a drier or purge bin or storage bin. In other embodiments the improved morphology comprises feature (ii) and decreasing the APS of the polyolefin particles (e.g., polyethylene particles), which indicates an overall shifting of the particle size distribution curve to lower diameters. In other embodiments the APS of the polyolefin particles is decreased by from 5% to 30%, or from 12% to 22%, or from 14% to 20%. All other things being equal, polyolefin particles (e.g., polyethylene particles) having a decreased APS may beneficially have easier processability in a melt extruder/pelletizer operation.

In some embodiments the improved morphology comprises feature (iii) narrowing the particle size distribution of the polyolefin particles (e.g., polyethylene particles). To provide a way of quantifying the narrowing of the particle size distribution, we use herein a particle size ratio d90/d10, wherein d90 is the particle size at 90% volume fraction of the polyolefin powder and d10 is the particle size at 10% volume fraction of the polyolefin powder (e.g., polyethylene powder). The 90% volume fraction means the particle size that is larger than 90% by volume of all particles in the polyolefin powder and 10% volume fraction means the particle size that is larger than 10% by volume of all particles in the polyolefin powder. The smaller the particle size ratio d90/d10, the narrower the particle size distribution. In some embodiments the particle size ratio d90/d10 is from 3.0 to 4.0, alternatively from 3.10 to 3.75. In some embodiments the feature (ill) is described as a percentage decrease in inventive d90/d10 relative to a comparative d90/d10. In some embodiments feature (iii) comprises a percentage decrease in inventive d90/d10 relative to a comparative d90/d10 of from 4% to 30%, or from 10% to 30%, or from 11% to 28%, or from 23% to 28%. The comparative d90/d10 is measured on a comparative polyolefin powder (e.g., comparative polyethylene powder) made under the same gas phase polymerization conditions as the inventive polyolefin powder (inventive polyethylene powder) except where the SD/SIS-metallocene catalyst is used in the comparative polymerization instead of the inventive reactive polyolefin prepolymer (e.g., reactive polyethylene prepolymer).

The method as described above wherein the morphology of the morphology-improved polyethylene powder comprises: (1) an amount of polyethylene fines that is lower by from 5% to 60%, or from 9% to 55%, or from 20% to 55%, or from 30% to 55% relative to an amount of polyethylene fines in a comparative polyethylene powder made by an identical gas phase polymerization except wherein the spray-dried silica-supported metallocene catalyst is used instead of the reactive olefin prepolymer; and (ii) an average particle size (APS) that is higher by from 9% to 50%, or from 9% to 42%, or from 30% to 50% relative to the APS of the comparative polyethylene powder; and (iii) a percentage decrease in inventive d90/d10 relative to a comparative d90/d10 of from 10% to 30%, or from 11% to 28%, or from 23% to 28%. Alternatively the method as described above wherein the morphology of the morphology-improved polyethylene powder comprises: (i) an amount of polyethylene fines that is lower by from 5% to 60%, or from 9% to 55% %, or from 20% to 55%, or from 30% to 55% relative to an amount of polyethylene fines in a comparative polyethylene powder made by an identical gas phase polymerization except wherein the spray-dried silica-supported metallocene catalyst is used instead of the reactive olefin prepolymer; (ii) an average particle size (APS) that is lower by from 11% to 20%, or from 14% to 19%, relative to the APS of the comparative polyethylene powder; and (iii) a percentage decrease in inventive d90/d10 relative to a comparative d90/d10 of from 4% to 30%, or from 10% to 30%, or from 11% to 28%, or from 23% to 28%.

The method as described above wherein the greater the amount of polyethylene fines in the comparative polyethylene powder the greater the percent decrease in polyethylene fines in the morphology-improved polyethylene powder.

The method as described above wherein compared with a comparative polyethylene powder made from the SD/SIS-metallocene catalyst, the particle size distribution (PSD) of the morphology-improved polyethylene powder is narrower when determined by sieving the polyethylene powder through a stack of meshes of progressively smaller sized openings. Narrower PSD means the range of particle sizes is smaller, which means the difference between the largest particle size and the smallest particle size is smaller. This is illustrated in FIG. 3. FIG. 3 is a plot of weight percent (wt %) particles versus mesh sizes (MSH) of particles for two comparative polyethylene powders (both designated “G1 t-in-t, side flow 16-PL”) two inventive morphology-improved polyethylene powders (designated “20 g/g @ 50 C, side flow 16-PL” and “40 g/g @ 50 C, side flow 16-PL”, wherein 20 g/g and 40 g/g mean 20 grams or 40 grams, respectively of reactive olefin prepolymer per 1.0 gram of SD/SIS-metallocene catalyst used to obtain the prepolymer, 50 C means 50° C.). In FIG. 3 “side flow” means a nitrogen gas was fed via a side inlet into the reactor and 16-PL is a batch number. The U.S. mesh sizes used for this measurement and shown in FIG. 3 are, from largest openings to smallest openings: 10 mesh (10 MSH, 2000 μm), 18 mesh (18 MSH, 1000 μm), 35 mesh (35 MSH, 500 μm), 60 mesh (60 MSH, 250 μm), 120 mesh (120 MSH, 125 μm), 200 mesh (200 MSH, 74 μm), and PAN (less than 74 μm). Optionally a 325 mesh (44 μm) sieve may be inserted between the 200 mesh and the PAN. The wt % values in FIG. 3 are the mass of polyethylene powder caught by the different mesh sizes.

The method as described above having any one of limitations (i) to (iii): (i) wherein the morphology-improved polyethylene powder has from 2.5 weight percent (wt %) to no more than 5.5 wt % of polyethylene fines, which is defined as polyethylene particles having diameters of 74 micrometers (μm) or less; (ii) wherein the morphology-improved polyethylene powder has an average particle size from 0.360 mm to 0.480 mm; or (iii) both limitations (i) and (ii).

The method as described above having any one of limitations (i) to (iii): (i) the temperature of the gas phase reactor is from 70° to 120° C., from 80° to 115° C., or from 81° to 89° C.; (ii) the gas phase reactor also contains from 1 weight percent (wt %) to 20 wt % of an induced condensing agent (“ICA”) selected from a (C₅-C₇)alkane, wherein preferably the ICA is isopentane, based on total weight of contents in the gas phase reactor; or (iii) both limitations (i) and (ii).

The method inhibits catalyst light-off and reactor overheating and fouling. The method inhibits light-off of a SD/SiS-metallocene catalyst and decreases overheating and fouling in a gas phase reactor. The method improves gas phase reactor operability by lengthening the time between reactor shutdowns for cleaning and improving quality and consistency of the composition, resin properties, and performance of the polyethylene powders made thereby.

A conventionally-dried silica-supported metallocene catalyst typically can be fed into a gas phase reactor without causing significant overheating or fouling.

The method improves morphology of polyethylene powders. The method also improves the morphology of the polyethylene powder. The morphology improvement comprises: (i) inhibiting formation of polyethylene particles that are too small (fines), which is defined as polyethylene particles having diameters of 74 micrometers or less; and (ii) increasing average particle size (APS), which indicates a shifting of the particle size distribution curve to higher diameters.

The method employs the reactive olefin prepolymer. The reactive olefin prepolymer comprises the component that is a polyolefin and the component that is an active metallocene derivative of a spray-dried silica-supported metallocene catalyst (“SD/SiS-metallocene catalyst”). The reactive olefin prepolymer has a prepolymer/catalyst weight/weight ratio from 10:1.0 to 50:1.0, wherein the prepolymer weight is the total weight of the reactive olefin prepolymer and the catalyst weight is the weight of the spray-dried silica-supported metallocene catalyst. If the prepolymer/catalyst weight/weight ratio is too low, i.e., less than 10:1.0, then there may be too little olefin prepolymer component and consequently the light-off of the SD/SiS-metallocene catalyst may be too fast and may not be sufficiently inhibited, which could result in greater overheating and fouling in the gas phase reactor. If the prepolymer/catalyst weight/weight ratio is too high, i.e., greater than 50:1.0, then there may be too much olefin prepolymer component and consequently the light-off of the SD/SIS-metallocene catalyst may be too slow and may be over inhibited, which could decrease the catalytic activity of the method.

The reactive olefin prepolymer is made by polymerization of an olefin monomer in a hydrocarbon diluent under mild conditions using a spray-dried, silica-supported metallocene catalyst. The reactive olefin prepolymer is made by combining a measured preparatory amount of an olefin monomer with a measured amount of the spray-dried silica-supported metallocene catalyst in an alkane liquid phase in a slurry phase reactor at a temperature from 30° to 70° C., an ethylene partial pressure of no more than 861 kpa, and a total reactor pressure of no more than 2450 kpa to make the reactive olefin prepolymer via slurry phase polymerization. The measured preparatory amount of olefin monomer and the measured amount of the spray-dried silica-supported metallocene catalyst result in the reactive olefin prepolymer having the prepolymer/catalyst weight/weight ratio from 10:1.0 to no more than 50:1.0, wherein the prepolymer weight is the total weight of the reactive olefin prepolymer and the catalyst weight is the weight of the spray-dried silica-supported metallocene catalyst. The prepolymer/catalyst weight/weight ratio may be adjusted within this range by using higher or lower amounts of the spray-dried silica-supported metallocene catalyst relative to the amount of olefin monomer. If the polymerization temperature is too low, i.e., less than 30° C., then the slurry phase polymerization may take too long to make the reactive olefin prepolymer and/or the weight/weight ratio of prepolymer/catalyst may be too low, which can result in the problems discussed earlier. If the polymerization temperature is too high, i.e., greater than 70° C., then the slurry phase polymerization may overheat and/or the weight/weight ratio of prepolymer/catalyst may be too high, which can result in the problems discussed earlier. In some embodiments the olefin monomer used to make the reactive olefin prepolymer comprises at least 90 wt % ethylene, or consists of 100 wt % ethylene, and the reactive olefin prepolymer is the reactive ethylene prepolymer described earlier.

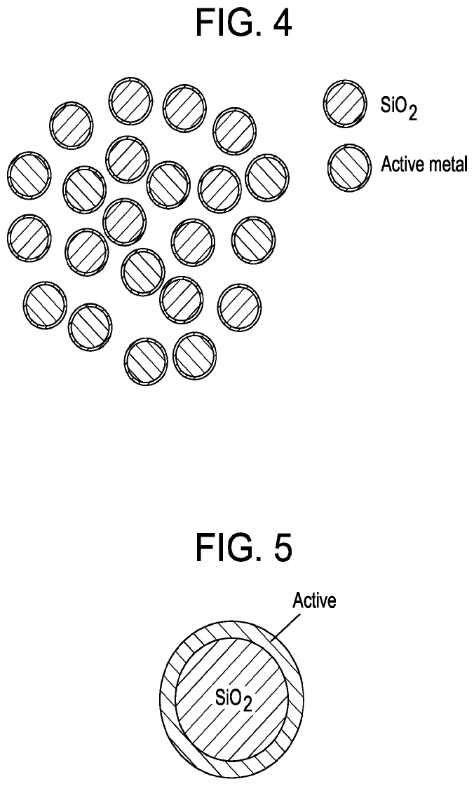

The spray-dried silica-supported metallocene catalyst. Any spray-dried silica-supported metallocene catalyst may be used in the method. The SD/SiS-metallocene catalyst is made by spray drying a mixture of two or more of its reactants in a hydrocarbon diluent. Any spray drying method may be used. The reactants used to make the SD/SiS-metallocene catalyst comprise a metallocene precatalyst, a silica support, and an activator. The SD/SIS-metallocene catalyst has a core-shell particle morphology. The particle morphology of the SD/SIS-metallocene catalyst is distinct from the particle morphology of a conventionally dried silica-supported metallocene catalyst prepared from the same constituents. These differences in particle morphologies are illustrated by comparing the cartoon drawings in FIGS. 4 and 5. FIG. 4 illustrates catalyst particle morphologies of a plurality of conventionally-dried, silica supported metallocene catalyst particles, wherein “SiO₂” identifies silica support particles and “active metal” identifies metallocene catalyst particles. The conventionally-dried catalyst comprises a matrix of distinct particles that are mostly silica and distinct particles that are mostly active metallocene catalyst. FIG. 5 illustrates core-shell catalyst particle morphology of a single particle of spray-dried, silica supported metallocene catalyst. The spray-dried, silica supported metallocene catalyst comprises a plurality of such core-shell particles. In each core-shell particle, the core is mostly silica and the shell is mostly active metallocene catalyst. In both the active metallocene catalyst refers to a product obtained by contacting a metallocene procatalyst (e.g., bis(n-propylcyclopentadienyl) hafnium dimethyl) with an activator (e.g., MAO). The morphologies are based on learnings from SEM images of conventionally dried or spray-dried catalyst particles. The cartoon drawings are not necessarily to scale (ignoring particle sizes), but merely serve to depict in a crude way these morphology differences. Comparing FIG. 4 with FIG. 5 shows how the conventionally dried silica-supported metallocene catalyst particles are a heterogeneous blend of different types of distinct particles: some particles are metallocene catalyst particles and other particles are activator/silica particles. In contrast, the SD/SIS-metallocene catalyst particles are a homogeneous blend of core-shell particles wherein the activator and metallocene catalyst constituents are located in the shells and the silica support is located in the cores of the core-shell particles.

The metallocene precatalyst. In some embodiments the metallocene precatalyst is as described in U.S. Pat. No. 7,873,112B2, column 11, line 17, to column 22, line 21. In some aspects the metallocene precatalyst is a species named in U.S. Pat. No. 7,873,112B2, column 18, line 51, to column 22, line 5.

In some embodiments the metallocene precatalyst is a compound of formula (I):

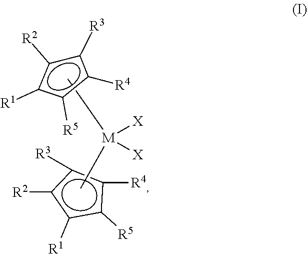

wherein M is Ti, Hf, or Zr; each R¹ to R⁵ is independently an unsubstituted (C₁-C₆)alkyl group or R¹ and R² on one of the cyclopentadienyl rings are bonded together to comprise a divalent hydrocarbylene selected from the group consisting of: —C(R^{a})═C(R^{b})—C(R^{c})═C(R^{d})— and —C(R^{a})₂—C(R^{b})₂—C(R^{c})₂—C(R^{d})₂—, wherein each of R^{a} to R^{d} independently is H or methyl; and each X is a leaving group selected from the group consisting of: a halide, an unsubstituted (C₁-C₆)alkyl group, benzyl, and trimethylsilylmethyl.

In some aspects the metallocene precatalyst is selected from bis(η⁵-tetramethylcyclopentadienyl)zirconium dichloride; bis(η⁵-tetramethylcyclopentadienyl)zirconium dimethyl; bis(η⁵-pentamethylcyclopentadienyl)zirconium dichloride; bis(η⁵-pentamethylcyclopentadienyl)zirconium dimethyl; (1,3-dimethyl-4,5,6,7-tetrahydroindenyl)(1-methylcyclopentadienyl)zirconium dimethyl; bis(1-methyl-3-n-butylcyclopentadienyl)zirconium dichloride; bis(1-methyl-3-n-butylcyclopentadienyl)zirconium dimethyl; bis(n-propylcyclopentadienyl) hafnium dichloride; bis(n-propylcyclopentadienyl) hafnium dimethyl; bis(n-butylcyclopentadienyl)zirconium dichloride; (cyclopentadienyl)(1,5-dimethylindenyl)zirconium dimethyl; (methylcyclopentadienyl)(1,5-dimethylindenyl)zirconium dimethyl; (cyclopentadienyl)(1,4-dimethylindenyl)zirconium dimethyl; (methylcyclopentadienyl)(1,4-dimethylindenyl)zirconium dimethyl; and bis(n-butylcyclopentadienyl)zirconium dimethyl. In some aspects the metallocene catalyst is a product of an activation reaction of an activator and any one of the aforementioned metallocene precatalysts.

In some embodiments the compound of formula (I) is of formula (Ia):

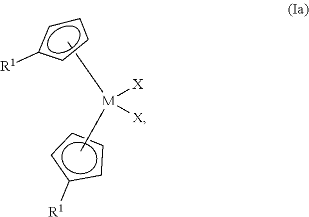

wherein M is Hf or Zr, each R¹ is independently a (C₁-C₆)alkyl group, and each X is the leaving group. In some embodiments the metallocene precatalyst is of formula (Ia) wherein M is Hf, each R¹ is CH₂CH₂CH₃, and each X is Cl or methyl. The latter metallocene precatalysts are the bis(n-propylcyclopentadienyl) hafnium dichloride and the bis(n-propylcyclopentadienyl) hafnium dimethyl.

The silica support. The silica support is a particulate solid of amorphous silicon dioxide. The silica support may be semi-porous, or porous. The silica support independently may be an untreated fumed silica, alternatively a calcined untreated fumed silica, alternatively a hydrophobing agent-treated fumed silica, alternatively a calcined and hydrophobing agent-treated fumed silica.

Prior to being contacted with a catalyst or precatalyst, the silica support may be pre-treated by heating the silica support in air to give a calcined silica support. The pre-treating comprises heating the silica support at a peak temperature from 350° to 850° C., alternatively from 400° to 800° C., alternatively from 400° to 700° C., alternatively from 500° to 650° C. and for a time period from 2 to 24 hours, alternatively from 4 to 16 hours, alternatively from 8 to 12 hours, alternatively from 1 to 4 hours, thereby making a calcined silica support. The silica support may be a calcined silica support.

The silica support has variable surface area, pore volume, and average particle size. In some embodiments, the silica support has a surface area from 10 to 1000 square meter per gram (m²/g), an average particle size from 20 to 300 micrometers (μm), or both. The surface area is from 200 to 600 m²/g. The silica support may have a surface area in the range of from about 10 m²/g to about 700 m²/g, a pore volume in the range of from about 0.1 cm³/g to about 4.0 cm³/g, and average particle size in the range of from about 20 microns to about 500 μm.

The silica support may have a pore volume from 0.5 to 6.0 cubic centimeters per gram (cc/g) or a pore volume from 1.1 to 1.8 cc/g and the surface area is from 245 to 375 m²/g. Alternatively, the pore volume is from 2.4 to 3.7 cc/g and the surface area is from 410 to 620 m²/g. Alternatively, the pore volume is from 0.9 to 1.4 cc/g and the surface area is from 390 to 590 m²/g. Each of the above properties are measured using conventional techniques known in the art.

The silica support may an amorphous silica (not quartz), alternatively a high surface area amorphous silica (e.g., from 500 to 1000 m²/g). Such silicas are commercially available from several sources including the Davison Chemical Division of W. R. Grace and Company (e.g., Davison 952 and Davison 955 products), and PQ Corporation (e.g., ES70 product). The silica support may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

The fumed silica may be hydrophilic (untreated), alternatively hydrophobic (treated). In some aspects the silica support is a hydrophobic fumed silica. Hydrophobic fumed silica is a product of pre-treating a hydrophilic fumed silica (untreated) with a silicon-based hydrophobing agent selected from trimethylsilyl chloride, dimethyldichlorosilane, a polydimethylsiloxane fluid, hexamethyldisilazane, an octyltrialkoxysilane (e.g., octyltrimethoxysilane), and a combination of any two or more thereof; alternatively dimethyldichlorosilane. Examples of the hydrophobic fumed silica are CAB-O-SIL hydrophobic fumed silicas available from Cabot Corporation, Alpharetta Georgia, USA. When the hydrophobing agent is dimethyldichlorosilane, an example of a hydrophobic fumed silica is CAB-O-SIL TS610 from Cabot Corporation. In some aspects the silica support is a hydrophobic fumed silica that has been surface treated with dimethyldichlorosilane ((CH₃)₂SiCl₂); this silica support is commercially available from Cabot Corporation as Cabosil™ TS-610.

The activator. Any activator may be the same or different as another and independently may be a Lewis acid, a non-coordinating ionic activator, or an ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Zr) may be 1000:1 to 0.5:1, alternatively 300:1 to 1:1, alternatively 150:1 to 1:1. Suitable activators are commercially available.

The spray-dried silica-supported metallocene catalyst (“SD/SIS-metallocene catalyst”) is made by spray-drying a mixture of a metallocene precatalyst, a silica support, an activator, and a hydrocarbon diluent. Spray drying methods and equipment are well known in the catalyst art and include those described in U.S. Pat. No. 5,648,310.

The hydrocarbon diluent. The hydrocarbon diluent may be an alkane, an arene, an alkylarene (e.g., toluene), or an arylalkane (e.g., phenylpropane). Examples of hydrocarbon diluents are alkanes such as mineral oil, pentanes, hexanes, heptanes, octanes, nonanes, decanes, undecanes, dodecanes, etc., and toluene, and xylenes. In one embodiment, the hydrocarbon diluent is an alkane, or a mixture of alkanes, wherein each alkane independently has from 4 to 20 carbon atoms, alternatively from 5 to 12 carbon atoms, alternatively from 5 to 10 carbon atoms. Each alkane independently may be acyclic or cyclic. Each acyclic alkane independently may be straight chain or branched chain. The acyclic alkane may be 2-methylpropane (isobutane), pentane, 1-methylbutane (isopentane), hexane, 1-methylpentane (isohexane), heptane, 1-methylhexane (isoheptane), octane, nonane, decane, or a mixture of any two or more thereof. The cyclic alkane may be cyclopentane, cyclohexane, cycloheptane, cyclooctane, cyclononane, cyclodecane, methycyclopentane, methylcyclohexane, dimethylcyclopentane, or a mixture of any two or more thereof. Additional examples of suitable alkanes include Isopar-C, Isopar-E, and mineral oil such as white mineral oil. In some aspects the hydrocarbon diluent is free of mineral oil. The hydrocarbon diluent may consist of one or more (C₅-C₁₂)alkanes. In some embodiments the hydrocarbon diluent is isopentane.

The SD/SiS-metallocene catalyst differs in composition and catalytic activity from a conventionally-dried supported metallocene catalyst by virtue of their different drying preparations.

The olefin monomer. The olefin monomer used to make the reactive olefin prepolymer and the olefin monomer used to make the polyethylene powder may be the same or different. The olefin used to make the polyethylene powder comprises ethylene. The olefin monomer used to make the reactive olefin prepolymer may be any olefin selected from the group consisting of: ethylene, propene, a (C₄-C₂₀)alpha-olefin, or a combination of any two or more thereof. In some embodiments the olefin monomer used to make the prepolymer and the powder are the same. The (C₄-C₂₀)alpha-olefin may be (C₄-C₁₀)alpha-olefin or a (C₄-C₈)alpha-olefin. In embodiments the (C₄-C₈)alpha-olefin independently may be 1-butene, 1-pentene, 1-hexene, 4-methyl-1-pentene, 1-heptene, or 1-octene; alternatively 1-butene. 1-hexene, or 1-octene; alternatively 1-butene or 1-hexene; alternatively 1-hexene or 1-octene; alternatively 1-butene; alternatively 1-hexene; alternatively 1-octene; alternatively a combination of 1-butene and 1-hexene; alternatively a combination of 1-hexene and 1-octene. Typically the 1-alkene may be 1-hexene.

The slurry phase reactor. Slurry phase reactors are well known in the art. Any slurry phase reactor capable of polymerizing ethylene may be used.

The gas phase reactor. Gas phase reactors and methods are well known in the art. Any gas phase reactor for polymerizing ethylene may be used. For example, the FB-GPP reactor/method may be as described in U.S. Pat. Nos. 3,709,853; 4,003,712; 4,011,382; 4,302,566; 4,543,399; 4,882,400; 5,352,749; 5,541,270; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

The gas phase reactor may be a fluidized-bed gas phase polymerization (FB-GPP) reactor and the effective polymerization conditions may comprise the following reaction conditions: the FB-GPP reactor having a fluidized bed at a bed temperature from 70 to 120 degrees Celsius (° C.); the FB-GPP reactor receiving feeds of the reactive olefin prepolymer, and independently controlled amounts of ethylene and, optionally, an olefin comonomer in an ethylene/comonomer molar ratio. The gas phase reactor may optionally receive a feed hydrogen gas (H₂) for controlling molecular weight of the polyethylene powder in a hydrogen-to-ethylene (H₂/C₂) molar ratio or by weight parts per million H₂ to mole percent C₂ ratio (H₂ ppm/C₂ mol %). The gas phase reactor may also receive a feed of an induced condensing agent (ICA) for controlling heat in the reactor.

In some embodiments the FB-GPP reactor is a commercial scale reactor described in WO 2016/172567 A1 by Savatsky et al. for Univation Technologies, LLC, Houston, Texas.

In some embodiments the FB-GPP reactor is a commercial scale reactor such as a UNIPOL™ reactor, which is available from Univation Technologies, LLC, a subsidiary of The Dow Chemical Company. Midland, Michigan, USA.

Induced condensing agent (ICA). In gas phase reactors an ICA may be used in condensing mode to absorb heat of the exothermic polymerization reaction. The ICA is typically one or more (C₅-C₁₀)alkanes. The ICA may be fed separately into the FB-GPP reactor or as part of a mixture also containing the reactive olefin prepolymer. The ICA may be a (C₅-C₂₀)alkane, alternatively a (C₅-C₁₀)alkane, alternatively a (C₅)alkane, e.g., pentane or 2-methylbutane; a hexane; a heptane; an octane; a nonane: a decane; or a combination of any two or more thereof. Typically the ICA is isopentane (2-methylbutane). The aspects of the polymerization method that use the ICA may be referred to as being an induced condensing mode operation (ICMO). ICMO is described in U.S. Pat. Nos. 4,453,399; 4,588,790; 4,994,534; 5,352,749; 5,462,999; and 6,489,408. The concentration of ICA in the reactor is measured indirectly as total concentration of vented ICA in recycle line using gas chromatography by calibrating peak area percent to mole percent (mol %) with a gas mixture standard of known concentrations of ad rem gas phase components.

The polymerization conditions may further include one or more additives such as a chain transfer agent or a promoter.

The reactive olefin prepolymer is made by slurry phase polymerization in a slurry phase reactor, which is different than the gas phase polymerization and reactor that makes the morphology-improved polyethylene powder. The components of the reactive olefin prepolymer are in the same particles thereof. I.e., not particles of olefin prepolymer component blended with particles of catalyst component.

The step of removing catalyst fines from the spray-dried silica-supported metallocene catalyst may comprise sieving or electrostatic filtering the spray-dried silica-supported metallocene catalyst. In some embodiments the spray-dried silica-supported metallocene catalyst has from 10 weight percent (wt %) to no more than 40 wt % catalyst fines, defined as catalyst particles having diameters of 10 micrometers (μm) or less. In some embodiments the SD/SIS-metallocene catalyst has from 20 wt % to 35 wt % catalyst fines, alternatively from 24 wt % to 31 wt % catalyst fines, alternatively from 23 wt % to 27 wt % catalyst fines, alternatively from 28 wt % to 32 wt % catalyst fines, alternatively 25 wt %±1 wt % catalyst fines, alternatively 30 wt %±1 wt % catalyst fines.

The spray-dried silica-supported metallocene catalyst is made before and separate from making the reactive olefin prepolymer, and the reactive olefin polymer is made before and separate from the making of the polyolefin powder.

The morphology-improved polyethylene powder has decreased amount of polyethylene agglomerates relative to amount of polyethylene agglomerates in the comparative polyethylene powder.

The catalytic activity of the reactive olefin prepolymer is from 90% to less than or equal to 100% of catalytic activity of the spray-dried silica-supported metallocene catalyst when measured by gas phase polymerization of ethylene in a reactor at 85° C., an ethylene partial pressure of 1034 kpa, and total reactor pressure of 2447 kpa.

The weight/weight ratio of the alkane liquid phase to total olefin monomer is from 5:1.0 to 800:1.0.

The alkane of the liquid phase has from 4 to 10 carbon atoms per molecule.

The olefin prepolymer has a number-average molecular weight (Mₙ) from 5.000 grams per mole to 50,000 g/mol.

In some embodiments the metallocene precatalyst is bis(n-propylcyclopentadienyl) hafnium dichloride or bis(n-propylcyclopentadienyl) hafnium dimethyl, which are metallocene precatalysts of formula (Ia):

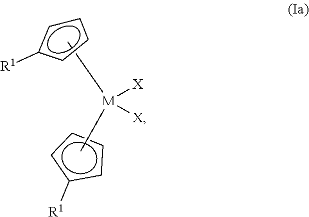

wherein M is Hf, each R¹ is CH₂CH₂CH₃, and each X is Cl or methyl.

Catalytic activity is the mass of polyethylene powder made per unit weight of catalyst per hour.

Alternatively precedes a distinct embodiment. ASTM means the standards organization, ASTM International, West Conshohocken, Pennsylvania, USA. Any comparative example is used for illustration purposes only and shall not be prior art. Free of or lacks means a complete absence of; alternatively not detectable. ISO is International Organization for Standardization, Chemin de Blandonnet 8, CP 401-1214 Vernier, Geneva, Switzerland. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PAS is Publicly Available Specification, Deutsches Institut für Normunng e.V. (DIN, German Institute for Standardization) Properties may be measured using standard test methods and conditions. Ranges include endpoints, subranges, and whole and/or fractional values subsumed therein, except a range of integers does not include fractional values. Room temperature: 23° C.±1° C.

Terms used herein have their IUPAC meanings unless defined otherwise. For example, see Compendium of Chemical Terminology. Gold Book, version 2.3.3, Feb. 24, 2014.

Light-off Vial Test Method: add a mineral oil slurry of a faster-light-off catalyst supported on treated fumed silica or a mineral oil/toluene slurry of an attenuated post-metallocene catalyst supported on treated fumed silica into a dried 40 mL glass vial. To the vial add 5.5 mL or 11 mL of 1-octene, and seal the vial with a septum cap. Record addition time as T₀ (0.00 minute). Manually shake (not stir) the vials to prevent clumping. Then place the shaken vials in different wells of a foam block sitting on a hotplate/stirrer. Immediately insert thermocouples through the septa caps into the vials below the liquid level therein, and record temperatures (° C.) of the contents of the vials at 5 seconds intervals from T₀ to 300 minutes past T₀. Download the temperature and time data to a spreadsheet, and plot thermo-kinetic profiles for analysis. The results of these runs may be depicted graphically as a plot of reaction temperature of the batch reactor contents on the y-axis versus time starting from addition of Time₀ on the x-axis.

### EXAMPLES

The experimental approach comprises conducting a slurry phase polymerization of an olefin monomer with an SD/SIS metallocene catalyst in an appropriate solvent under milder conditions (35° to 50° C., ethylene partial pressure up to 861 kpa, and total reactor pressure up to 2450 kpa (355 pounds per square inch (psi))) to make a reactive olefin prepolymer with controlled morphology in a first step. To preserve undiminished catalytic activity of this reactive olefin prepolymer, the prepolymer is then fed directly into a gas phase reactor to polymerize ethylene to yield a polyethylene powder in a second step. This two-step sequence results in controlled catalytic activity in the gas phase reactor and allows for control of the level of fines generated in the gas phase reactor, and hence the morphology of the product polyethylene powder. Beneficially the controlled morphology of the reactive olefin prepolymer in the first step enables us to feed the prepolymer into the gas phase reactor using a simple 0.635 cm (¼ inch) inner diameter feed injection tube instead of an elaborate tube-in-tube feed injector system commonly used for feeding SD/SIS metallocene catalyst into gas phase reactors.

Fines Test Method: fines are measured using a 200 mesh sieve (74 μm).

Average Particle Size (APS) and Particle Size Distribution (PSD) Test Method: average particle size (APS) and particle size distribution (PSD) are measured using a series of sieves from 10 mesh size to 325 mesh size, alternatively from 10 mesh size to 200 mesh size. The various mesh sizes and their respective micrometer dimensions are described elsewhere herein. This is the test method used to measure the APS data of the examples shown in later Table 1 and to generate the particle size distributions of the examples shown in FIG. 3.

Volume Fraction Particle Size Test Method: volume fraction particle sizes, including the d90 particle size at 90% volume fraction and the d10 particle size at 10% volume fraction, are measured using a Mastersizer 3000 particle size analyzer instrument from Malvern Panalytical Ltd, a Spectris company. This is the test method used to generate the d90 and d10 data used to calculate the d90/d10 ratios shown later in Table 1.

Preparation 1: for the examples, a SD/SiS-metallocene catalyst was made as follows. A mixture of a metallocene precatalyst, bis(n-propylcyclopentadienyl) hafnium dimethyl, a hydrophobic fumed silica support, dichlorodimethylsilane-treated fumed silica, and an activator, methyl aluminoxane (MAO), in mineral oil/ISOPAR C was made. The mixture contained 16.4 wt % solids powder. The solids powder contained 0.8 wt % Hf atoms and 16.4 wt % aluminum atoms based on total weight of the solids powder. The mixture was spray-dried under the following conditions to make an SD/SIS-metallocene catalyst, a spray-dried silica-supported bis(n-propylcyclopentadienyl) hafnium dimethyl catalyst. Spray drying conditions: spray drier apparatus having an outlet temperature of 80° C. and an atomizer speed of 22,500 rotations per minute (rpm). The resulting spray-dried silica-supported bis(n-propylcyclopentadienyl) hafnium dimethyl catalyst contained 0.045 millimoles (mmol) of Hf atoms and 6 mmol of Al atoms (from activator) per 1.0 gram total weight of SD/SIS-metallocene catalyst. If used in a comparative example to polymerize ethylene in a gas phase reactor, this catalyst can produce a comparative polyethylene powder containing up to 10 wt % polyethylene fines. The catalyst of Preparation 1 was made in one lot. Two samples (Sample A and Sample B) were removed at different times from the lot and were found to have different amounts of catalyst fines. Sample A contained 30.2 wt % catalyst fines (particles having a diameter of 10 μm or less) and Sample B contained 25 wt % catalyst fines.

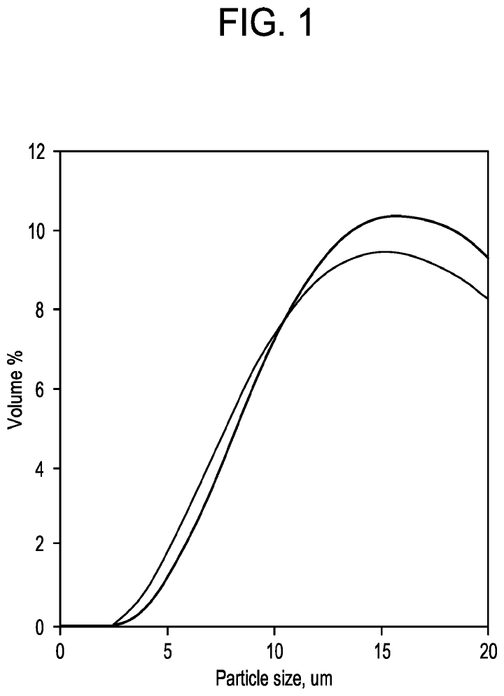

FIG. 1 is a plot of volume percent (volume %) (y-axis) versus particle size in micrometers (μm) (x-axis) for the SD/SIS-metallocene catalysts of Sample A and Sample B of Preparation 1. In FIG. 1 the plot of Sample A has the shortest peak with a maximum volume % at a particle size of about 15 μm and Sample B has the tallest peak with a maximum volume % at a particle size of about 16 μm.

Comparative Example 1 (CE1): gas phase polymerization of ethylene with spray-dried silica-supported bis(n-propylcyclopentadienyl) hafnium catalyst of Sample A of Preparation 1 in a gas phase reactor at a temperature of 85° C., ethylene partial pressure of 1034 kpa, and total reactor pressure of 2413 kpa and containing 15% isopentane to make a comparative polyethylene powder having: (i) 6.0 wt % polyethylene fines having a diameter of from greater than 0 μm to 74 μm; and (ii) an average particle size (APS) of 0.333 millimeter (mm).

Comparative Example 2 (CE2): gas phase polymerization of ethylene with spray-dried silica-supported bis(n-propylcyclopentadienyl) hafnium catalyst of Sample B of Preparation 1 in a gas phase reactor at a temperature of 85° C., ethylene partial pressure of 1034 kpa, and total reactor pressure of 2413 kpa and containing 15% isopentane to make a comparative polyethylene powder having: (i) 3.0 wt % polyethylene fines having a diameter of from greater than 0 μm to 74 μm; and (ii) an APS of 0.457 mm.

Examples of the inventive method improve the morphology of polyethylene powders as follows. Examples of the reactive olefin prepolymer containing different loadings of the spray-dried silica-supported bis(n-propylcyclopentadienyl) hafnium dimethyl catalyst were made by slurry phase polymerizations of ethylene monomer at different reactor temperatures.

Inventive Example 1A (IE1A, 35° C., 20 g/1.0 g): a reactive olefin prepolymer that is a reactive ethylene prepolymer was made by slurry phase polymerization of a measured amount of ethylene with a measured amount of the spray-dried silica-supported bis(n-propylcyclopentadienyl) hafnium catalyst of Sample A of Preparation 1 in isopentane at reactor temperature of 35° C., ethylene partial pressure of 158.7 kpa, and total reactor pressure of 2447 kpa to make a reactive ethylene prepolymer comprising a component that is a polyethylene prepolymer and a component that is an active metallocene derivative of the spray-dried silica-supported bis(n-propylcyclopentadienyl) hafnium catalyst, wherein the reactive ethylene prepolymer has a prepolymer/catalyst weight/weight ratio of 20 grams:1.0 gram, wherein the prepolymer weight is the total weight of the reactive ethylene prepolymer and the catalyst weight is the weight of the spray-dried silica-supported metallocene catalyst.

Inventive Example 1B (IE1B): gas phase polymerization of ethylene with reactive ethylene prepolymer of IE1A in a gas phase reactor at a temperature of 85° C., ethylene partial pressure of 1034 kpa, and total reactor pressure of 2413 kpa yielded a morphologically-improved polyethylene powder having: (i) 5.3 wt % polyethylene fines having a diameter of from greater than 0 μm to 74 μm, a decrease of 11% relative to the polyethylene fines of the comparative polyethylene powder of Comparative Example 1; and (ii) an APS of 0.363 mm, an increase of 9.0% relative to the APS of the comparative polyethylene powder.

Inventive Example 2A (IE2A, 50° C., 20 g/1.0 g): a reactive olefin prepolymer that is a reactive ethylene prepolymer was made by slurry phase polymerization of a measured amount of ethylene with a measured amount of the spray-dried silica-supported bis(n-propylcyclopentadienyl) hafnium catalyst of Sample A of Preparation 1 in isopentane at reactor temperature of 50° C., ethylene partial pressure of 158.7 kpa, and total reactor pressure of 2447 kpa to make a reactive ethylene prepolymer comprising a component that is a polyethylene prepolymer and a component that is an active metallocene derivative of the spray-dried silica-supported bis(n-propylcyclopentadienyl) hafnium catalyst, wherein the reactive ethylene prepolymer has a prepolymer/catalyst weight/weight ratio of 20 grams:1.0 gram, wherein the prepolymer weight is the total weight of the reactive ethylene prepolymer and the catalyst weight is the weight of the spray-dried silica-supported metallocene catalyst.

Inventive Example 2B (IE2B): gas phase polymerization of ethylene with reactive ethylene prepolymer of IE2A in a gas phase reactor at a temperature of 85° C., ethylene partial pressure of 1034 kpa, and total reactor pressure of 2413 kpa yielded a morphologically-improved polyethylene powder having: (i) 2.6 wt % polyethylene fines having a diameter of from greater than 0 μm to 74 μm, a decrease of 56% relative to the polyethylene fines of the comparative polyethylene powder of Comparative Example 1; and (ii) an APS of 0.467 mm, an increase of 40.2% relative to the APS of the comparative polyethylene powder.

Inventive Example 3A (IE3A, 50° C., 40 g/1.0 g): a reactive olefin prepolymer that is a reactive ethylene prepolymer was made by slurry phase polymerization of a measured amount of ethylene with a measured amount of the spray-dried silica-supported bis(n-propylcyclopentadienyl) hafnium catalyst of Sample A of Preparation 1 in isopentane at reactor temperature of 50° C., ethylene partial pressure of 279.2 kpa, and total reactor pressure of 2447 kpa to make a reactive ethylene prepolymer comprising a component that is a polyethylene prepolymer and a component that is an active metallocene derivative of the spray-dried silica-supported bis(n-propylcyclopentadienyl) hafnium catalyst, wherein the reactive ethylene prepolymer has a prepolymer/catalyst weight/weight ratio of 40 grams:1.0 gram, wherein the prepolymer weight is the total weight of the reactive ethylene prepolymer and the catalyst weight is the weight of the spray-dried silica-supported metallocene catalyst.

Inventive Example 3B (IE3B): gas phase polymerization of ethylene with reactive ethylene prepolymer of IE3A in a gas phase reactor at a temperature of 85° C., ethylene partial pressure of 1034 kpa, and total reactor pressure of 2413 kpa yielded a morphologically-improved polyethylene powder having: (i) 3.10 wt % polyethylene fines having a diameter of from greater than 0 μm to 74 μm, a decrease of 48% relative to the polyethylene fines of the polyethylene powder of Comparative Example 1; and (ii) an APS of 0.470 mm, an increase of 41.1% relative to the APS of the comparative polyethylene powder.

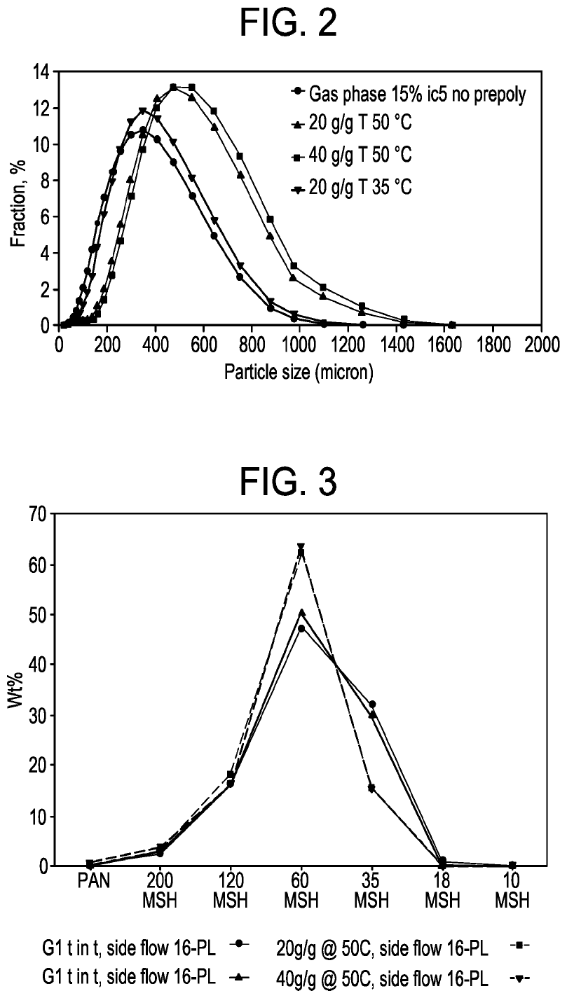

FIG. 2 is a plot of volume fraction in percent (Fraction, %) (y-axis) versus particle size in micrometers (Particle Size (microns)) on a scale from 0 μm to 2,000 μm for Comparative Example 1 and Inventive Examples 1B, 2B, and 3B. “Microns” are also represented as μm. The results shown in FIG. 2 illustrate the decrease in fines and increase in APS of the improved morphology polyethylene powder relative to the comparative polyethylene powder.

Inventive Example 4A (IE4A, 50° C., 20 g/1.0 g): a reactive olefin prepolymer that is a reactive ethylene prepolymer was made by slurry phase polymerization of a measured amount of ethylene with a measured amount of the spray-dried silica-supported bis(n-propylcyclopentadienyl) hafnium catalyst of Sample B of Preparation 1 in isopentane at reactor temperature of 50° C., ethylene partial pressure of 83.2 kpa, and total reactor pressure of 2447 kpa to make a reactive ethylene prepolymer comprising a component that is a polyethylene prepolymer and a component that is an active metallocene derivative of the spray-dried silica-supported bis(n-propylcyclopentadienyl) hafnium catalyst, wherein the reactive ethylene prepolymer has a prepolymer/catalyst weight/weight ratio of 20 grams:1.0 gram, wherein the prepolymer weight is the total weight of the reactive ethylene prepolymer and the catalyst weight is the weight of the spray-dried silica-supported metallocene catalyst.

Inventive Example 4B (IE4B): gas phase polymerization of ethylene with reactive ethylene prepolymer of IE4A in a gas phase reactor at a temperature of 85° C., ethylene partial pressure of 1034 kpa, and total reactor pressure of 2413 kpa yielded a morphologically-improved polyethylene powder having: (i) 2.0 wt % polyethylene fines having a diameter of from greater than 0 μm to 74 μm, a decrease of 33% relative to the polyethylene fines of the comparative polyethylene powder of Comparative Example 2; and (ii) an APS of 0.381 mm, a decrease of 16.6% relative to the APS of the comparative polyethylene powder.

The results for Comparative Examples 1 and 2 and Inventive Examples 1B, 2B, 3B, and 4B are shown in Table 1.

TABLE 1
weight percent fines and APS.

| | Preparation of Reactive Ethylene Prepolymers | | | | | |
|---|---|---|---|---|---|---|
| Example | CE1 | IE1A | IE2A | IE3A | CE2 | IE4A |
| SD/SiS-Metallocene | None | Prep. 1, | Prep. 1. | Prep. 1, | None | Prep. 1, |
| Catalyst Used | | Sample A | Sample A | Sample A | | Sample B |
| Catalyst Fines (wt %) | 30.2 | 30.2 | 30.2 | 30.2 | 25 | 25 |
| Slurry Phase Temp. | None | 35 | 50 | 50 | None | 50 |
| (° C.) | | | | | | |
| Prepolymer/ | None | 20/1.0 | 20/1.0 | 40/1.0 | None | 20/1.0 |
| Derivative wt/wt | | | | | | |

| | Preparation of Polyethylene (PE) Powder | | | | | |
|---|---|---|---|---|---|---|
| Example | CE1 | IE1B | IE2B | IE3B | CE2 | IE4B |
| PE Powder Fines | 6.0 | 5.3 | 2.6 | 3.10 | 3.0 | 2.0 |
| (wt %) | | | | | | |
| % Decrease Fines | 0 | 11 | 56 | 48 | 0 | 33 |
| APS (μm) | 0.333 | 0.363 | 0.467 | 0.470 | 0.457 | 0.381 |
| % change in APS | 0 | +9.0 | +40.2 | +40.1 | 0 | −16.6 |
| d90/d10 | 4.21 | 3.73 | 3.2 | 3.11 | 4.48 | 4.29 |
| Narrowing of particle | None | 11.4 | 24.0 | 26.1 | None | 4.2 |
| size distribution, % | | | | | | |

In Table 1, the inventive method improved morphology of polyethylene powders made in gas phase reactors by decreasing the wt % polyethylene (PE) fines. The improved morphology polyethylene powders of IE1B to IE3B had increased average particle size (APS) of the inventive polyethylene powders relative to their comparative polyethylene powder. The improved morphology polyethylene powder of IE4B had decreased average particle size (APS) of the inventive polyethylene powder relative to its comparative polyethylene powder.

1. A method of making a morphology-improved polyethylene powder, the method comprising:
contacting ethylene with a reactive olefin prepolymer in a gas phase reactor to make a morphology-improved polyethylene powder via gas phase polymerization;
wherein the reactive olefin prepolymer comprises a component that is a polyolefin and a component that is an active metallocene derivative of a spray-dried silica-supported metallocene catalyst; wherein the reactive olefin prepolymer has a prepolymer/catalyst weight/weight ratio from 10:1.0 to 50:1.0, wherein the prepolymer weight is the total weight of the reactive olefin prepolymer and the catalyst weight is the weight of the spray-dried silica-supported metallocene catalyst.

2. The method as claimed in claim 1 comprising making the reactive olefin prepolymer by combining a measured preparatory amount of an olefin monomer with a measured amount of the spray-dried silica-supported metallocene catalyst in an alkane liquid phase in a slurry phase reactor at a temperature from 30° to 70° C., an ethylene partial pressure of no more than 861 kpa, and a total reactor pressure of no more than 2450 kpa to make the reactive olefin prepolymer via slurry phase polymerization; wherein the measured preparatory amount of olefin monomer and the measured amount of the spray-dried silica-supported metallocene catalyst result in the prepolymer/catalyst weight/weight ratio from 10:1.0 to no more than 50:1.0, wherein the prepolymer weight is the total weight of the reactive olefin prepolymer and the catalyst weight is the weight of the spray-dried silica-supported metallocene catalyst.

3. The method as claimed in claim 1 having any one of limitations (i) to (iii):
(i) the prepolymer/catalyst weight/weight ratio is from 10:1.0 to 45:1.0, from 15:1.0 to 35:1.0, or from 15:1.0 to 25:1.0;
(ii) the temperature of the slurry phase reactor in claim 1 is from 35° to 70° C., from 40° to 60° C., or from 45° to 55° C.; or
(iii) the prepolymer/catalyst weight/weight ratio is from 15:1.0 to 25:1.0 and the temperature of the slurry phase reactor in claim 1 is from 45° to 55° C.

4. The method as claimed in claim 1 having limitation (i) and either limitation (ii) or limitation (iii):
(i) the reactive olefin prepolymer is a reactive ethylene prepolymer and the polyolefin of the reactive ethylene prepolymer is an ethylene homopolymer or an ethylene/(C₄-C₁₀)alpha-olefin copolymer; and
(ii) the gas phase reactor is free of an olefin comonomer and the morphology-improved polyethylene powder is an ethylene homopolymer; or
(iii) the gas phase reactor includes a (C₄-C₁₀)alpha-olefin comonomer and the morphology-improved polyethylene powder is an ethylene/(C₄-C₁₀)alpha-olefin copolymer.

5. The method as claimed in claim 1 comprising:
(i) feeding the reactive olefin prepolymer from a slurry phase reactor directly into the gas phase reactor; or
(ii) feeding the reactive olefin prepolymer from a slurry phase reactor into an intermediate vessel, waiting for a period of time, and then feeding the reactive olefin prepolymer from the intermediate vessel into the gas phase reactor.

6. The method as claimed in claim 1 wherein the reactive olefin prepolymer is fed via a single inlet tube into the gas phase reactor, wherein the single inlet tube has an inner diameter from 0.3 centimeter (cm) to 1.0 cm.

7. The method as claimed in claim 1 comprising making the spray-dried silica-supported metallocene catalyst by any one of preparations (i) to (iii):
(i) spray-drying a mixture of a metallocene precatalyst, a silica support, an activator, and hydrocarbon diluent to make the spray-dried silica-supported metallocene catalyst;
(ii) spray-drying a mixture of a silica support, an activator, and hydrocarbon diluent to give a spray-dried supported activator, and contacting the spray-dried supported activator with a metallocene precatalyst to make the spray-dried silica-supported metallocene catalyst; or
(iii) spray-drying a mixture of a metallocene precatalyst, a silica support, and hydrocarbon diluent to give a spray-dried supported metallocene precatalyst, and contacting the spray-dried supported metallocene precatalyst with an activator to make the spray-dried silica-supported metallocene catalyst;
wherein the hydrocarbon diluent is selected from the group consisting of an alkane, an aromatic hydrocarbon, an alkyl-substituted aromatic hydrocarbon, an aryl-substituted alkane, or a blend of any two or more thereof.

8. The method as claimed in claim 7 wherein the metallocene precatalyst is of formula (I): 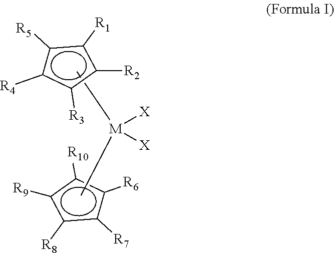
wherein M is Ti, Hf, or Zr; each R¹ to R⁵ is independently an unsubstituted (C₁-C₆)alkyl group or R¹ and R² on one of the cyclopentadienyl rings are bonded together to comprise a divalent hydrocarbylene selected from the group consisting of: —C(R^{a})═C(R^{b})—C(R^{c})═C(R^{d})— and —C(R^{a})₂—C(R^{b})₂—C(R^{c})₂—C(R^{d})₂—, wherein each of R^{a} to R^{d} independently is H or methyl; and each X is a leaving group.

9. The method as claimed in claim 7 wherein the metallocene precatalyst is selected from the group consisting of:
bis(η⁵-tetramethylcyclopentadienyl)zirconium dichloride;
bis(η⁵-tetramethylcyclopentadienyl)zirconium dimethyl;
bis(η⁵-pentamethylcyclopentadienyl)zirconium dichloride;
bis(η⁵-pentamethylcyclopentadienyl)zirconium dimethyl;
(1,3-dimethyl-4,5,6,7-tetrahydroindenyl)(1-methylcyclopentadienyl)zirconium dimethyl;
bis(1-methyl-3-n-butylcyclopentadienyl)zirconium dichloride;
bis(1-methyl-3-n-butylcyclopentadienyl)zirconium dimethyl;
bis(n-propylcyclopentadienyl) hafnium dichloride;
bis(n-propylcyclopentadienyl) hafnium dimethyl;
bis(n-butylcyclopentadienyl)zirconium dichloride;
(cyclopentadienyl)(1,5-dimethylindenyl)zirconium dimethyl;
(methylcyclopentadienyl)(1,5-dimethylindenyl)zirconium dimethyl;
(cyclopentadienyl)(1,4-dimethylindenyl)zirconium dimethyl;
(methylcyclopentadienyl)(1,4-dimethylindenyl)zirconium dimethyl; and
bis(n-butylcyclopentadienyl)zirconium dimethyl.

10. The method as claimed in claim 1 wherein the morphology of the morphology-improved polyethylene powder is further improved by removing at least some catalyst fines from the spray-dried silica-supported metallocene catalyst before making the reactive olefin prepolymer therewith, wherein catalyst fines are defined as catalyst particles having diameters of 10 micrometers (μm) or less.

11. The method as claimed in claim 1 wherein the morphology of the morphology-improved polyethylene powder comprises:
(i) an amount of polyethylene fines that is lower by from 5% to 60%, or from 9% to 55%, or from 20% to 55%, or from 30% to 55% relative to an amount of polyethylene fines in a comparative polyethylene powder made by an identical gas phase polymerization except wherein the spray-dried silica-supported metallocene catalyst is used instead of the reactive olefin prepolymer; and
(ii) an average particle size (APS) that is higher by from 9% to 50%, or from 9% to 42%, or from 30% to 50% relative to the APS of the comparative polyethylene powder; or (ii) the APS of the polyolefin particles is decreased by from 5% to 30%, or from 12% to 22%, or from 14% to 20%;
(iii) the particle size distribution is described as a percentage decrease in inventive d90/d10 relative to a comparative d90/d10 of from 4% to 30%, or from 10% to 30%, or from 11% to 28%, or from 23% to 28%;
(iv) both feature (i) and a feature (ii);
(v) both feature (i) and feature (iii);
(vi) both feature (ii) and feature (iii); or
(vii) each of features (i), (ii), and (iii).

12. The method as claimed in claim 11 wherein the greater the amount of polyethylene fines in the comparative polyethylene powder the greater the percent decrease in polyethylene fines in the morphology-improved polyethylene powder.

13. The method as claimed in claim 1 wherein the morphology of the morphology-improved polyethylene powder comprises:
(i) an amount of polyethylene fines that is lower by from 10% to 60%, or from 20% to 55%, or from 30% to 55% relative to an amount of polyethylene fines in a comparative polyethylene powder made by an identical gas phase polymerization except wherein the spray-dried silica-supported metallocene catalyst is used instead of the reactive olefin prepolymer;
(ii) an average particle size (APS) that is lower by from 11% to 20%, or from 14% to 19%, relative to the APS of the comparative polyethylene powder; or
(iii) both (i) and (ii).

14. The method as claimed in claim 1 having any one of limitations (i) to (iii):
(i) wherein the morphology-improved polyethylene powder has from 2.5 weight percent (wt %) to no more than 5.5 wt % of polyethylene fines, which is defined as polyethylene particles having diameters of 74 micrometers (μm) or less;
(ii) wherein the morphology-improved polyethylene powder has an average particle size from 0.360 mm to 0.480 mm; or
(iii) both limitations (i) and (ii).

15. The method as claimed in claim 1 having any one of limitations (i) to (iii):
(i) the temperature of the gas phase reactor is from 70° to 120° C., from 80° to 115° C., or from 81° to 89° C.;
(ii) the gas phase reactor also contains from 1 weight percent (wt %) to 20 wt % of an induced condensing agent (“ICA”) selected from a (C₅-C₇)alkane, wherein preferably the ICA is isopentane, based on total weight of contents in the gas phase reactor; or
(iii) both limitations (i) and (ii).
